(19) United States
(12) Patent Application Publication
(10) Pub. No.: US 2014/0200992 A1
(43) Pub. Date: Jul. 17, 2014

(54) RETAIL PRODUCT LAGGED PROMOTIONAL EFFECT PREDICTION SYSTEM

(71) Applicant: ORACLE INTERNATIONAL CORPORATION, Redwood Shores, CA (US)

(72) Inventors: Z. Maria WANG, Needham, MA (US); Peter GAIDAREV, Charlestown, MA (US)

(73) Assignee: Oracle International Corporation, Redwood Shores, CA (US)

(21) Appl. No.: 13/740,570

(22) Filed: Jan. 14, 2013

(51) Int. Cl. G06Q 30/02

(52) U.S. Cl. CPC G06Q 30/0246
USPC 705/14.45

(57) ABSTRACT

A system for predicting a lagged promotional effect in response to a promotion of a product in a store receives historical sales data for the product in the store and stores the historical sales data in a panel data format. The stored sales data is aggregated to the store, product and a time period. The system then trains, validates and tests one or more candidate regression models using the historical sales data, and selects one of the one or more candidate regression models based on the validating and testing. The system then scores the selected regression model to determine a sales volume change for the product after the promotion.

### FIELD

One embodiment is directed generally to a computer system, and in particular to a computer system that estimates and predicts the lagged promotional effect for a retail product.

### BACKGROUND INFORMATION

Retailers frequently initiate promotions and/or marketing campaigns to boost sales and ultimately increase profit. There are many types of promotions that a retailer may initiate depending on the time frame and the type of retail items, including temporary price cuts, price reductions with bundled buys or bonus buys, rebates, etc. Further, the promotions can be advertised in various formats through multiple channels, including an advertisement in a newspaper or a website, coupons and circulars using direct mail, in-store point-of-purchase display, etc.

During a promotion time period, sales volume of the merchandise items being promoted are expected to increase as a result of a temporarily enlarged customer base of the store and/or greater purchase amount per customer of the promoted items. However, the effect of promotions on sales and revenue is not limited to the promotion time only, as the sales volume and profit during post-promotion time periods can be affected to a varying extent. In order for a retailer to gauge the impact of a promotion accurately, the indirect promotional effects across post-promotion time periods cannot be neglected.

Commonly observed promotional effects during post-promotion periods can be referred to as the “lagged promotional effect”, “pantry-loading” or the “stockpiling effect.” During the week(s) following a promotion, sales of the previously promoted merchandise can drop below a normal sales level (baseline) for a regular week without promotions adjusted by trend and seasonality. Such sales reductions may last one week or longer before the sales get back to the baseline. The depth of the “dip” in sales varies among merchandise items and also depends on many other factors, such as how deep the price cut was and how publicized the promotional event was in the preceding promotions.

In general, the lagged promotional effect typically occurs because a shopper bought more of a product than they usually buy or need to buy because the offer was so good. Consequently they likely will not buy that item again in the near term because they have “stocked up.” For example, if a shopper usually buys a 6-pack of soda every week, but because of a great sale buys a 24-pack, which will last four weeks, that shopper will likely not buy soda again for four weeks. When contemplating a promotion, the lagged promotional or pantry effect needs to be taken into account when optimizing the overall profit or revenue of a retail store.

### SUMMARY

One embodiment is a system for predicting a lagged promotional effect in response to a promotion of a product in a store. The system receives historical sales data for the product in the store and stores the historical sales data in a panel data format. The stored sales data is aggregated to the store, product and a time period. The system then trains, validates and tests one or more candidate regression models using the historical sales data, and selects one of the one or more candidate regression models based on the validating and testing. The system then scores the selected regression model to determine a sales volume change for the product after the promotion.

### BRIEF DESCRIPTION OF THE DRAWINGS

FIG. 1 is a block diagram of a computer system that can implement an embodiment of the present invention.

FIG. 2 is a flow diagram of the functionality of a lagged promotional effect module of FIG. 1 when determining a lagged promotional effect in accordance with one embodiment.

### DETAILED DESCRIPTION

One embodiment is a computer system for predicting a lagged promotional effect on retail sales for a product by aggregating past historical sales in a panel data format, selecting a regression model from one or more candidate model forms, estimating the model parameters, and then predicting the lagged effect using the selected model. The predicted lagged promotional effect can be used as an input to a retail sales optimization system in order to optimize revenue or other performance indicator for the retailer.

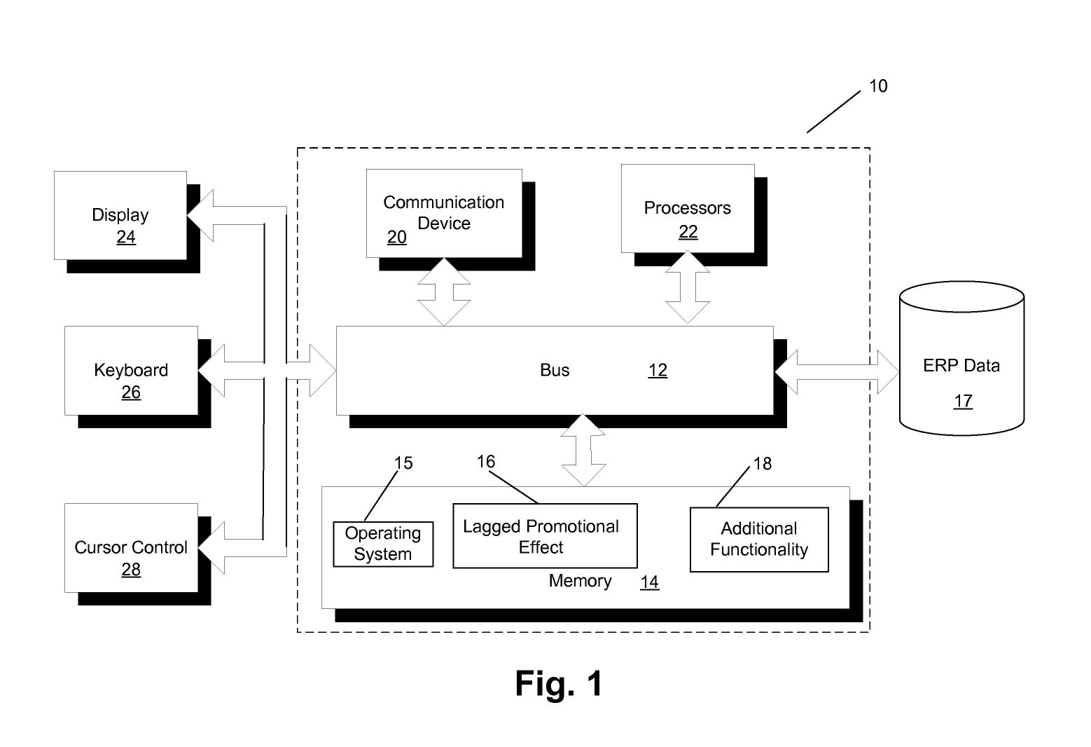

FIG. 1 is a block diagram of a computer system 10 that can implement an embodiment of the present invention. Although shown as a single system, the functionality of system 10 can be implemented as a distributed system. Further, all of the elements shown in FIG. 1 may not be included in some embodiments. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a lagged promotional effect module 16 that predicts/estimates the lagged promotional effect for a retail product as disclosed in more detail below. System 10 can be part of a larger system, such as “Retail Demand Forecasting” from Oracle Corp., which provides retail sales forecasting, or “Retail Markdown Optimization” from Oracle Corp., which determines pricing/promotion optimization for retail products, or part of an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing data and ERP data such as inventory information, etc.

In one embodiment, in order to predict a lagged promotional effect, past historical sales data for a retail store is collected. The data can be in the form of point-of-sale (“POS”) data, sales transaction data or customer market-basket data. In one embodiment, a minimum of one year of historical data for a retail store is collected. The data is collected for a specific retail product or “Stock Keeping Unit” (“SKU”).

In one embodiment, the data is processed and stored in a panel data format. In general, “panel data” refers to multi-dimensional data. Panel data contains observations on multiple phenomena observed over multiple time periods for the same stores. In one embodiment, the data columns correspond to merchandise attributes, time, sales and promotion information, and the data rows are the values of the column fields for multiple merchandise items and multiple time periods. The data is aggregated to the level of STORE/WEEK/SKU level. Therefore, the following three column fields determine one unique data row:
SKU Identifier (“ID”);
Fiscal week;
Retail store ID.

Data values of quantifiable columns, such as sales unit, price, promotion discount, etc., are averaged per week/store/SKU. For qualitative variables, such as promotion type and promotion theme, if one SKU of one store has multiple values within one week, the multiple values can be either grouped as a new variable value, or the majority value of the variable is taken.

In one embodiment, data fields to be collected and/or created for statistical regression include one or more of the following:
Retail store ID;
SKU ID;
Category ID;
Fiscal week, month and year;
Sales volume of the SKU;
Sales price (averaged per SKU/store/fiscal week);
Promotion indicator of SKU/store/fiscal week;
Price reduction of the promotion, if applicable;
Promotion duration in days;
Promotion type (i.e., promotion techniques used for the SKU/store week, e.g., single item price deduction, price percentage off, bundled buys, bonus buys, etc.);
Promotion channel, format and vehicle (e.g., circulars, TV ads, direct mail, end-cap display, meal deal, etc.);
Promotion ads features (e.g., first page features, end page features, etc.).

In one embodiment, additional data fields are derived from the above collected data fields. The additional data fields/variables include one or more of the following:

### Normalized Price Index

The normalized price index variable is the paid price normalized by the regular price of the SKU at the store. The normalized price index variable is denoted as [symbol] , (i.e., the normalized price for SKU i at store j during week t). It is derived by [symbol] =Priceᵢⱼₜ/ P̅r̅i̅c̅e̅ᵢ̅ⱼ̅ₜ̅ where Priceᵢⱼₜ denotes the (averaged) paid price of SKU i at store j during week t, and P̅r̅i̅c̅e̅ᵢ̅ⱼ̅ₜ̅ denotes the regular price (median price) of the SKU throughout the time period of the model training period.

### Promotion Week Indicator

The promotion week indicator is an indicator (binary) variable indicating whether the SKU/store/week is associated with a promotion. The promotion week indicator is denoted as Prom_{0,ijt}, and is assigned a value 1 for week t if a promotion occurs on SKU i of store j; otherwise 0.

### Post-Promotion Time Period Indicators

Post-promotion time period indicators are binary lag variables, indicating the week(s) immediately after a promotional week of the SKU at the store. Depending on the frequency of promotions on the SKU, multiple weeks after a promotion, minimum 1 and maximum 4, should be augmented with these type of lag variables. The post-promotion time period indicators are denoted as PostProm_{1,ijt}, PostProm_{2,ijt}, PostProm_{3,jft}, PostProm_{4,jft}, separately for the indicator variables for the four consecutive post-promotion weeks (t+1), (t+2), (t+3) and (t+4) of SKU i of store j for promotion at week t.

### Baseline Sales Volume

The baseline sales volume variable is determined by using all non-promotional weeks, moving averages of the most recent four weeks—two weeks forward and two weeks backward—of sales volume are taken for all weeks as the baseline sales.

### Promotion Days

Promotion days is the duration of the promotion in days that has its inception in week t for SKU i of store j. The promotion days variable is denoted as PromDaysᵢⱼₜ for SKU i of store j week t.

### Lagged Sales Lift Shocks

The lagged sales shocks variable is for the sales lift of the precedent promotion week, padded in the following week for lagging effect modeling (Model Form 3). The lagged promotion shocks variable is denoted by SalesLiftᵢⱼₜ.

In one embodiment, the data in the data panel is filtered as follows:
Rows with zero or negative sales volumes should be removed;
Rows accounted for the top and bottom 2% of promotion lift should be removed;
Rows with missing information on promotion characteristics (promotion type, format, vehicle etc.) should be removed in the units of SKU/week.

One embodiment uses one or more regression predictive models to predict the lagged promotion effect. One or more of the following variables are used for the predictive models:

yᵢⱼₜ: Unit sales volume of SKU i, store j and week t; [symbol]
: Normalized price index for SKU i at store j during week t. [symbol] ≅Priceᵢⱼₜ/ P̅r̅i̅c̅e̅ᵢ̅ⱼ̅ₜ̅, where Priceᵢⱼₜ denotes the average paid price of SKU i at store j during week t, and P̅r̅i̅c̅e̅ᵢ̅ⱼ̅ₜ̅ denotes the regular (median) price of the SKU throughout the time period of the model training period;
SKuᵢⱼ: Intercept for SKU i of store j;
Prom_{0,ijt}: Promotion indicator variable for SKU i of store j and week t. If there are promotions for SKU i of store j and week t, Prom_{0,ijt}=1 otherwise 0;
PostProm_{m,ijt}: Post-promotion week indicator variable for SKU i of store j and week (t+1), (t+2), . . . , (t+M); if Prom_{0,ijt}=1, i.e., there are promotions for SKU i of store j and week t, PostProm_{m,ijt}=1; otherwise 0. M: maximum number of weeks to be considered for post-promotion weeks; 4 is used in one embodiment;
SalesLift_{0,ijt}: Sales lift (promotion lift if in a promotion week as a special case) for SKU i of store j at week t;
ΔPrice_{m,ijt}: Price difference between week (t+m) and promotion week t for SKU i of store j;
PromDaysᵢⱼₜ: Promotion duration in days for SKU i, store j, week t;
Dummy_{k,ijt}: Set of dummy variables that represent the set of promotional characteristics including promotion type, promotion format or vehicle, promotion features;
Seasonᵢⱼₜ: Variable for seasonality;
Trendᵢⱼₜ: Trending variable to de-trend the data. A time index, e.g. cumulative week or month can be used here;
εᵢⱼₜ: Residual error term of the model;
αᵢⱼₜ: Intercept for fixed-effect of SKU i, store j, week t;
βᵢⱼₜ: Price term coefficient, i.e. price elasticity, for SKU i, store j, week t;
θ_{m,ijt}: Pantry loading effect elasticities separately for week m of SKU i, store j, week t;
γ_{k,ijt}: Coefficients of promotion characteristic k for SKU i, store j, week t;
μ_{1,ijt}: Coefficient of promotion duration for SKU i, store j, week t;
μ_{2,ijt}: Coefficient of seasonality variable for SKU i, store j, week t;
μ_{3,ijt}: Coefficient of trending variable for SKU i, store j, week t.

In one embodiment, the training and testing data sets are prepared. The preparation includes the following in one embodiment:
The processed data set (with selected and derived fields as described above) is randomly sampled by starting week for 20 times with minimum 52 consecutive weeks for each sample.
Each of the 20 sample data sets is divided using the 80-20 rule for the weeks covered in the complete data set into {training, testing} sets (i.e., 80% (weeks) for training and 20% (weeks) for testing). For each data set (training or testing), it should contain consecutive weeks.
Two data sets (training and testing) in each pair should contain the same set of SKU's and promotion characteristics. The data is further cleaned if the conditions are not met.

As disclosed, one embodiment uses one or more regression predictive models to predict the lagged promotional effect. When more than one candidate regression model is used, the “best” or “champion” model is selected. In one embodiment, three model forms (i.e., “Model Form 1”, “Model Form 2” and “Model Form 3”) are used as candidate models. The three regression model forms in one embodiment are as follows:

### Model Form 1

The Model Form 1 regression model predicts store weekly sales for each single SKU of a store and a week. It captures the following effects:
Sales price effect during promotion weeks;
Post-promotion pantry-loading effect with a constant dipping factor (θ_{m,ijt}) across all SKU's and all types of promotions;
Promotion duration effect;
Effects from promotion characteristics: promotion techniques, delivery channel and format, advertisements, and features;
Seasonality of sales;
Trend of sales;
Recommended M=4. This value can be adjusted (between 1 and 4) as the modeler deems appropriate.

$$ln ( {y}_{ijt} ) = {α}_{ijt} {SKU}_{ijt} + {β}_{ijt} ln ( ) * {Prom}_{0 , ijt} + {\sum }_{k = 1}^{K} {γ}_{k , ijt} {Dummy}_{k , ijt} + {μ}_{1 , ijt} {PromDays}_{ijt} + {μ}_{2 , ijt} {Season}_{ijt} + {μ}_{3 , ijt} {Trend}_{ijt} + {\sum }_{m = 1}^{M} {θ}_{m , ijt} {PostProm}_{m , ijt} + {ɛ}_{ijt}$$

### Model Form 2

The Model Form 2 differs from Model Form 1 in that it becomes a dynamic linear regression model but considers the lagged effect of price in the form of price difference in the model. Sales price during promotion week is considered to affect the subsequent post-promotion sales dips and thus dipping effect (θ_{m,ijt}ΔPrice_{m,ijt}) varies with the price difference (ΔPrice_{m,ijt}) between the post-promotion week and the promotion week:

$$ln ( {y}_{ijt} ) = {α}_{ijt} {SKU}_{ijt} + {β}_{ijt} ln ( ) * {Prom}_{0 , ijt} + {\sum }_{m = 1}^{M} {θ}_{m , ijt} \cdot Δ {Price}_{m , ijt} \cdot {PostProm}_{m , ijt} + {{\sum }_{k = 1}}^{K} {γ}_{k , ijt} {Dummy}_{k , ijt} + {μ}_{1 , ijt} {PromDays}_{ijt} + {μ}_{2 , ijt} {Season}_{ijt} + {μ}_{3 , ijt} {Trend}_{ijt} + {ɛ}_{ijt}$$

### Model Form 3

Model Form 3 differs from Model Forms 1 and 2 for at least the following reasons:
Sales lift during promotion period is considered to affect post-promotion pantry-loading effect so that post-promotion sales dip is subject to the precedent promotional lift;
An autoregressive distributed-lag (“ARDL”) model is applied. Autocorrelation between a general sales fluctuation (lift or dip) in the current week and its following week is considered, so that a sales lift or dip in any week can potentially affect the next week's sales. Post-promotion pantry-loading is one of the autocorrelation relationship for two consecutive weeks to be modeled
Value of m is 1

$$ln ( {y}_{ijt} ) = {α}_{ijt} {SKU}_{ijt} + {β}_{ijt} ln ( ) * {Prom}_{0 , ijt} + {θ}_{m , ijt} {SalesLift}_{0 , ijt} \cdot {PostProm}_{m , ijt} + {{\sum }_{k = 1}}^{K} {γ}_{k , ijt} {Dummy}_{k , ijt} + {μ}_{1 , ijt} {PromDays}_{ijt} + {μ}_{2 , ijt} {Season}_{ijt} + {μ}_{3 , ijt} {Trend}_{ijt} + {ɛ}_{ijt}$$

In one embodiment, each of the above models is validated and tested as follows:

The models are estimated using an Ordinary Least Square (“OLS”) method. The goodness-of-fit from in-sample training is evaluated by:
Adjusted R-square;
Signs and significance (p-value) of model coefficients for price and marketing effect variables including price, pantry loading effect;
The measures should be averaged over 20 training samples.

The models are further validated on the corresponding testing data set of the training set. Error measures to be used are:
“MPE” (Mean Percentage Error):

$$\frac{{\sum }_{i = 1}^{n} \frac{ln ( \hat{{y}_{1}} ) - ln ( {y}_{i} )}{ln ( {y}_{i} )}}{n} ;$$

“MedPE” (Median Percentage Error): median of

$$\frac{ln ( \hat{{y}_{1}} ) - ln ( {y}_{i} )}{ln ( {y}_{i} )} ;$$

“MAPE” (Mean Absolute Percentage Error):

$$\frac{{\sum }_{i = 1}^{n} \vert \frac{ln ( \hat{{y}_{1}} ) - ln ( {y}_{i} )}{ln ( {y}_{i} )} \vert}{n} ;$$

“WAPE” (Weighted Absolute Percentage Error):

$$\frac{{\sum }_{i = 1}^{n} \vert ln ( \hat{{y}_{1}} ) - ln ( {y}_{i} ) \vert}{{\sum }_{i = 1}^{n} \vert ln ( {y}_{i} ) \vert} ;$$

The measures should be averaged over 20 testing samples.

In one embodiment, after the models are validated and tested, one of the candidate models is selected (assuming there are more than one candidate models). For the model selection, the models are first filtered with the training measures. The recommended criteria to be taken are as follows, with the threshold for adjustment R-squared able to be adjusted as appropriate:
Average adjusted R-square >=50%;
Price coefficients (i.e. βᵢⱼₜ and θ_{m,ijt})<0.

The models are then filtered with testing errors. The recommended criteria are as follows. The thresholds for the error measures can be adjusted in other embodiments:
Average MPE should not go beyond +/−5%;
Average MedPE should not go beyond +/−5%;
Average MAPE<=30%;
Average WAPE<=30%.

Among the surviving models (i.e., those models not filtered out), the best model is selected based on average WAPE, or any other appropriate error measure.

After the best model is selected and its parameters are estimated, prediction of the lagged promotion effect is performed by scoring the data processed as required for {forecasting time period, store, product} of interest. The absolute sales volume change that lagged promotion effect accounts for in each model form is as follows:
Model Form 1: e^{Σ}^{ₘ₌₁}^{^{M}}^{θ}^{_{m,ijt}}^{PostProm}^{_{m,ijt}}
Model Form 2: e^{Σ}^{ₘ₌₁}^{^{M}}^{θ}^{_{m,ijt}}^{·ΔPrice}^{_{m,ijt}}^{·PostProm}^{_{m,ijt}}
Model Form 3: e^{θ}^{_{m,ijt}}^{SalesLift}^{_{0,ijt}}^{·PostProm}^{_{m,ijt}}
   Therefore, the input is the promotion, and the output is, for a particular SKU, week and store, the sales volume change after the promotion is over.

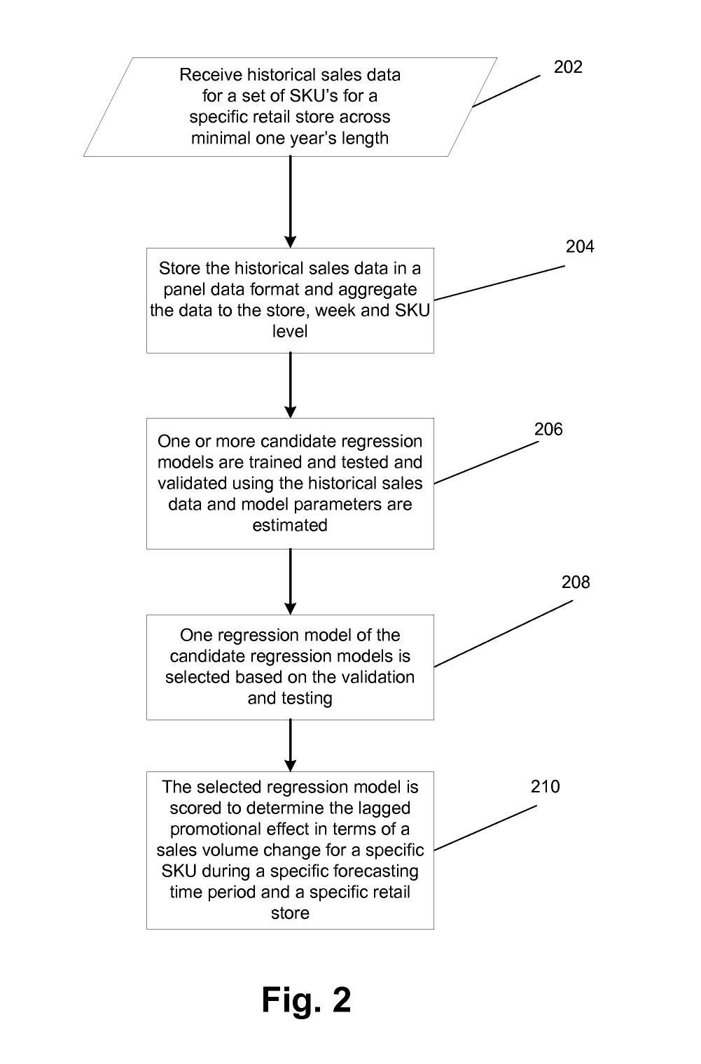

FIG. 2 is a flow diagram of the functionality of lagged promotional effect module 16 of FIG. 1 when determining a lagged promotion effect in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, the historical sales data for a set of SKU's for a specific retail store across minimal one year's length is received. The historical sales data in one embodiment can include point-of-sale (“POS”) data, sales transaction data or customer market-basket data.

At 204, the historical sales data is stored in a panel data format and the data is aggregated to the store, week and SKU level.

At 206, one or more candidate regression models are trained, validated and tested using the historical sales data, and model parameters are estimated. In one embodiment, the one or more candidate regression models are Model Form 1, Model Form 2 and Model Form 3, as described above.

At 208, one regression model of the candidate regression models is selected based on the validation and testing. If there is only one candidate regression model, then that model is selected.

At 210, the forecasting data set is first processed in the same way as the training data set to obtain the correct data format for the model predictor variables. The selected regression model is then scored by calculating the sales forecasting values for the new forecasting time period using the selected model form combined with the estimated model parameters and the values of the predictor variables (of the processed forecasting data), in order to determine the lagged promotional effect in terms of a sales volume change for a specific SKU for a specific time period at a specific retail store. The lagged promotional effect can be used as input to a retail sales forecast system in order to forecast future sales.

As disclosed, embodiments determine the lagged promotional effect using a data-driven analytical approach and data mining and regression modeling techniques for retail store promotions. Historical data is processed with certain techniques into a certain format as the modeling data set, and the lagged promotional effect or the pantry loading effect is extrapolated based on the modeling data set with model parameters estimated for the proposed statistical models and then used to predict the future pantry loading effect for planned promotions.

The disclosed regression models can capture the effect of precedent promotion lift on post-promotion pantry-loading effect (i.e., the post-promotion sales drop that is subject to precedent sales lift during the promotion period). In contrast, known prior art approaches either predict the effect at the household-level, which can be computationally demanding, or at a highly aggregate product level, most commonly seen is product brand level, and therefore do not provide merchandise level prediction. Embodiments of the present invention function at a merchandise (SKU) level of the retail store and directly solve the retailer's problem of quantifying and predicting post-promotion sales drop for every merchandise item. In addition, unlike prior art approaches that use structured modeling that solves multiple regression models simultaneously and thus computationally demanding, embodiments of the present invention eventually apply only one selected regression model for prediction (i.e., after evaluating one or more candidate models) and is more efficient and scalable for software implementation.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer-readable medium having instructions stored thereon that, when executed by a processor, cause the processor to predict a lagged promotional effect in response to a promotion of a product in a store, the predicting comprising:
receiving historical sales data for the product in the store;
storing the historical sales data in a panel data format;
aggregating the stored sales data, wherein the stored sales data is aggregated to the store, product and a time period;
training, validating and testing one or more candidate regression models using the historical sales data;
selecting one of the one or more candidate regression models based on the validating and testing; and
scoring the selected regression model to determine a sales volume change for the product after the promotion.

2. The computer-readable medium of claim 1, wherein the selected one of the one or more candidate regression models comprises a constant dipping factor across all products and all types of promotions.

3. The computer-readable medium of claim 1, wherein the selected one of the one or more candidate regression models comprises a dipping effect that varies with a price difference between a post-promotion time period and a promotion time period.

4. The computer-readable medium of claim 1, wherein the selected one of the one or more candidate regression models comprises autocorrelation between a sales fluctuation in a current time period and the following time period.

5. The computer-readable medium of claim 1, further comprising:
estimating model parameters.

6. The computer-readable medium of claim 5, wherein the scoring comprises:
determining sales forecasting values for a new forecasting time period using the selected model and the estimated model parameters and values of predictor variables.

7. The computer-readable medium of claim 5, wherein the estimating comprises ordinary least square estimating.

8. A computer-implemented method for predicting a lagged promotional effect in response to a promotion of a product in a store, the method comprising:
receiving historical sales data for the product in the store;
storing the historical sales data in a panel data format;
aggregating the stored sales data, wherein the stored sales data is aggregated to the store, product and a time period;
training, validating and testing one or more candidate regression models using the historical sales data;
selecting one of the one or more candidate regression models based on the validating and testing; and
scoring the selected regression model to determine a sales volume change for the product after the promotion.

9. The computer-implemented method of claim 8, wherein the selected one of the one or more candidate regression models comprises a constant dipping factor across all products and all types of promotions.

10. The computer-implemented method of claim 8, wherein the selected one of the one or more candidate regression models comprises a dipping effect that varies with a price difference between a post-promotion time period and a promotion time period.

11. The computer-implemented method of claim 8, wherein the selected one of the one or more candidate regression models comprises autocorrelation between a sales fluctuation in a current time period and the following time period.

12. The computer-implemented method of claim 8, further comprising:
estimating model parameters.

13. The computer-implemented method of claim 12, wherein the scoring comprises:
determining sales forecasting values for a new forecasting time period using the selected model and the estimated model parameters and values of predictor variables.

14. The computer-implemented method of claim 12, wherein the estimating comprises ordinary least square estimating.

15. A lagged promotional effect prediction system comprising:
a panel data storing module that receives historical sales data for a product in a store and stores the historical sales data in a panel data format and aggregates the stored sales data, wherein the stored sales data is aggregated to the store, product and a time period;
a model selector module that trains, validates and tests one or more candidate regression models using the historical sales data and selects one of the one or more candidate regression models based on the validating and testing; and
a scoring module that scores the selected regression model to determine a sales volume change for the product after a promotion.

16. The system of claim 15, wherein the selected one of the one or more candidate regression models comprises a constant dipping factor across all products and all types of promotions.

17. The system of claim 15, wherein the selected one of the one or more candidate regression models comprises a dipping effect that varies with a price difference between a post-promotion time period and a promotion time period.

18. The system of claim 15, wherein the selected one of the one or more candidate regression models comprises autocorrelation between a sales fluctuation in a current time period and the following time period.

19. The system of claim 15, wherein the model selector module further estimates model parameters.

20. The system of claim 19, wherein the scoring comprises:
determining sales forecasting values for a new forecasting time period using the selected model and the estimated model parameters and values of predictor variables.
